(19) United States
(12) Patent Application Publication
(10) Pub. No.: US 2010/0277470 A1
(43) Pub. Date: Nov. 4, 2010

(54) Systems And Methods For Applying Model Tracking To Motion Capture

(75) Inventor: Jeffrey Margolis, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/485,730

(22) Filed: Jun. 16, 2009

Related U.S. Application Data
(60) Provisional application No. 61/174,950, filed on May 1, 2009.

(51) Int. Cl. G06T 15/00; H04N 7/18

(52) U.S. Cl. 345/419; 348/135; 348/E07.085

(57) ABSTRACT

An image such as a depth image of a scene may be received, observed, or captured by a device and a model of a user in the image may be generated. The model may then be adjusted to mimic one or more movements by the user. For example, the model may be a skeletal model having joints and bones that may be adjusted into poses corresponding to the movements of the user in physical space. A motion capture file of the movement of the user may be generated in real-time based on the adjusted model. For example, a set of vectors that define the joints and bones for each of the poses of the adjusted model may be captured and rendered in the motion capture file.

### CROSS-REFERENCE TO RELATED APPLICATIONS

This application claims the benefit under 35 U.S.C. §119(e) of U.S. Provisional Patent Application No. 61/174,950, filed May 1, 2009, the disclosure of which is incorporated herein by reference.

### BACKGROUND

Many computing applications such as computer games, multimedia applications, or the like include avatars or characters that are animated using typical motion capture techniques. For example, when developing a golf game, a professional golfer may be brought into a studio having motion capture equipment including, for example, a plurality of cameras directed toward a particular point in the studio. The professional golfer may then be outfitted in a motion capture suit having a plurality of point indicators that may be configured with and tracked by the cameras such that the cameras may capture, for example, golfing motions of the professional golfer. The motions can then applied to an avatar or character during development of the golf game. Upon completion of the golf game, the avatar or character can then be animated with the motions of the professional golfer during execution of the golf game. Unfortunately, typical motion capture techniques are costly, tied to the development of a specific application, and do not include motions associated with an actual a player or user of the application.

### SUMMARY

Disclosed herein are systems and methods for capturing motions of a user in a scene. For example, an image such as depth of a scene may be received or observed. The depth image may then be analyzed to determine whether the image includes a human target associated with a user. If the image includes a human target associated with a user, a model of the user may be generated. The model may then be tracked in response to movement of the user such that the model may be adjusted to mimic the movement of the user. For example, the model may be a skeletal model having joints and bones that may be adjusted into poses corresponding to the movement of the user in physical space. According to an example embodiment, a motion capture file of the movement of the user may then be generated in real-time based on the tracked model. For example, a set of vectors that define the joints and bones for each of the poses of the adjusted model may be captured and rendered in the motion capture file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system.

FIG. 3 illustrates an example embodiment of a computing environment that may be used to interpret one or more gestures in a target recognition, analysis, and tracking system and/or animate an avatar or on-screen character displayed by a target recognition, analysis, and tracking system.

FIG. 4 illustrates another example embodiment of a computing environment that may be used to interpret one or more gestures in a target recognition, analysis, and tracking system and/or animate an avatar or on-screen character displayed by a target recognition, analysis, and tracking system.

FIG. 5 depicts a flow diagram of an example method for capturing motion of a human target.

FIG. 6 illustrates an example embodiment of a image that may include a human target.

FIG. 7 illustrates an example embodiment of a model that may be generated for a human target.

FIGS. 8A-8C illustrate an example embodiment of a model that may be captured at various points in time.

FIGS. 9A-9C illustrate an example embodiment of an avatar or game character that may be animated based on a model that may be captured at various points in time.

### DETAILED DESCRIPTION OF ILLUSTRATIVE EMBODIMENTS

As will be described herein, a user may control an application executing on a computing environment such as a game console, a computer, or the like and/or may animate an avatar or on-screen character by performing one or more gestures and/or movements. According to one embodiment, the gestures and/or movements may be received by, for example, a capture device. For example, the capture device may capture a depth image of a scene. In one embodiment, the capture device may determine whether one or more targets or objects in the scene corresponds to a human target such as the user. Each target or object that matches the corresponds to a human target may then be scanned to generate a model such as a skeletal model, a mesh human model, or the like associated therewith. The model may then be provided to the computing environment such that the computing environment may track the model, generate a motion capture file of the tracked model, render an avatar associated with the model, animate an avatar based on the motion capture file of the tracked model, and/or determine which controls to perform in an application executing on the computer environment based on, for example, the tracked model.

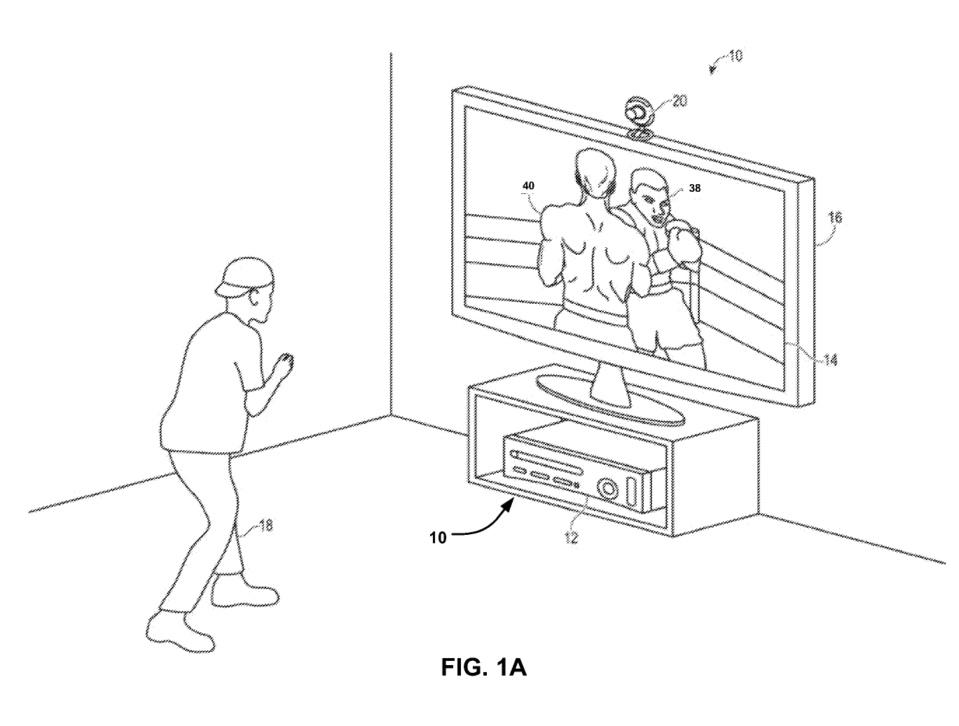

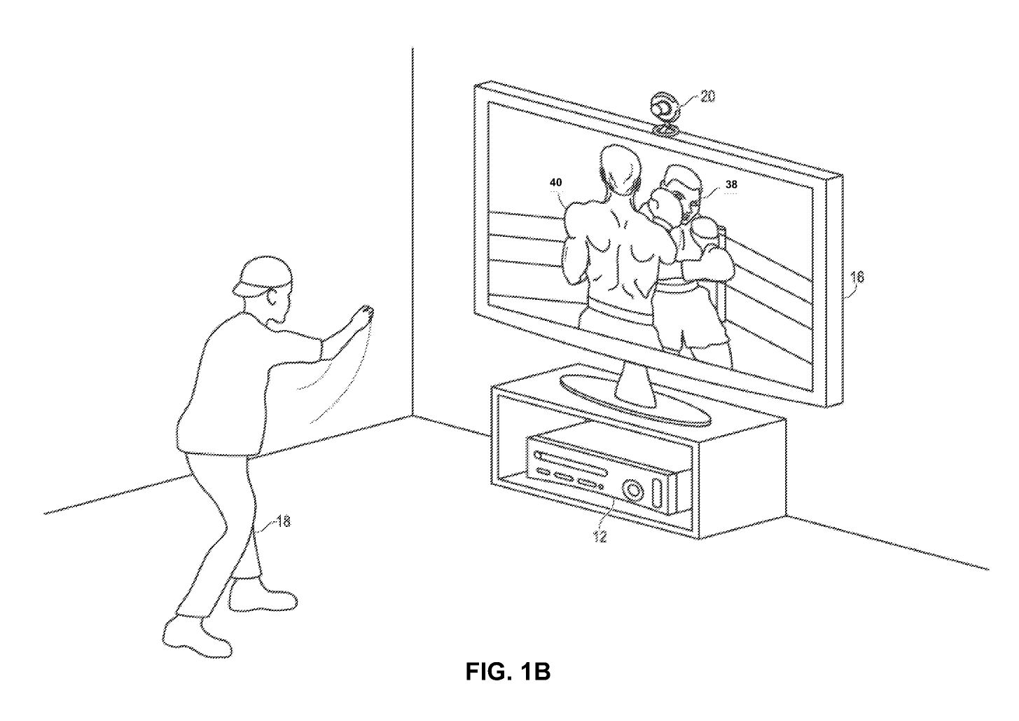

FIGS. 1A and 1B illustrate an example embodiment of a configuration of a target recognition, analysis, and tracking system 10 with a user 18 playing a boxing game. In an example embodiment, the target recognition, analysis, and tracking system 10 may be used to recognize, analyze, and/or track a human target such as the user 18.

As shown in FIG. 1A, the target recognition, analysis, and tracking system 10 may include a computing environment 12. The computing environment 12 may be a computer, a gaming system or console, or the like. According to an example embodiment, the computing environment 12 may include hardware components and/or software components such that the computing environment 12 may be used to execute applications such as gaming applications, non-gaming applications, or the like. In one embodiment, the computing environment 12 may include a processor such as a standardized processor, a specialized processor, a microprocessor, or the like that may execute instructions including, for example, instructions for receiving an image, generating a model of a user captured in the image, tracking the model, generating a motion capture file based on the tracked model, applying the motion capture file, or any other suitable instruction, which will be described in more detail below.

As shown in FIG. 1A, the target recognition, analysis, and tracking system 10 may further include a capture device 20. The capture device 20 may be, for example, a camera that may be used to visually monitor one or more users, such as the user 18, such that gestures and/or movements performed by the one or more users may be captured, analyzed, and tracked to perform one or more controls or actions within an application and/or animate an avatar or on-screen character, as will be described in more detail below.

According to one embodiment, the target recognition, analysis, and tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the target recognition, analysis, and tracking system 10 may be used to recognize, analyze, and/or track a human target such as the user 18. For example, the user 18 may be tracked using the capture device 20 such that the gestures and/or movements of user 18 may be captured to animate an avatar or on-screen character and/or may be interpreted as controls that may be used to affect the application being executed by computer environment 12. Thus, according to one embodiment, the user 18 may move his or her body to control the application and/or animate the avatar or on-screen character.

As shown in FIGS. 1A and 1B, in an example embodiment, the application executing on the computing environment 12 may be a boxing game that the user 18 may be playing. For example, the computing environment 12 may use the audiovisual device 16 to provide a visual representation of a boxing opponent 38 to the user 18. The computing environment 12 may also use the audiovisual device 16 to provide a visual representation of a player avatar 40 that the user 18 may control with his or her movements. For example, as shown in FIG. 1B, the user 18 may throw a punch in physical space to cause the player avatar 40 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 40 in game space and/or the motion of the punch may be used to animate the player avatar 40 in game space.

Other movements by the user 18 may also be interpreted as other controls or actions and/or used to animate the player avatar, such as controls to bob, weave, shuffle, block, jab, or throw a variety of different power punches. Furthermore, some movements may be interpreted as controls that may correspond to actions other than controlling the player avatar 40. For example, the player may use movements to end, pause, or save a game, select a level, view high scores, communicate with a friend, etc. Additionally, a full range of motion of the user 18 may be available, used, and analyzed in any suitable manner to interact with an application.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

According to other example embodiments, the target recognition, analysis, and tracking system 10 may further be used to interpret target movements as operating system and/or application controls that are outside the realm of games. For example, virtually any controllable aspect of an operating system and/or application may be controlled by movements of the target such as the user 18.

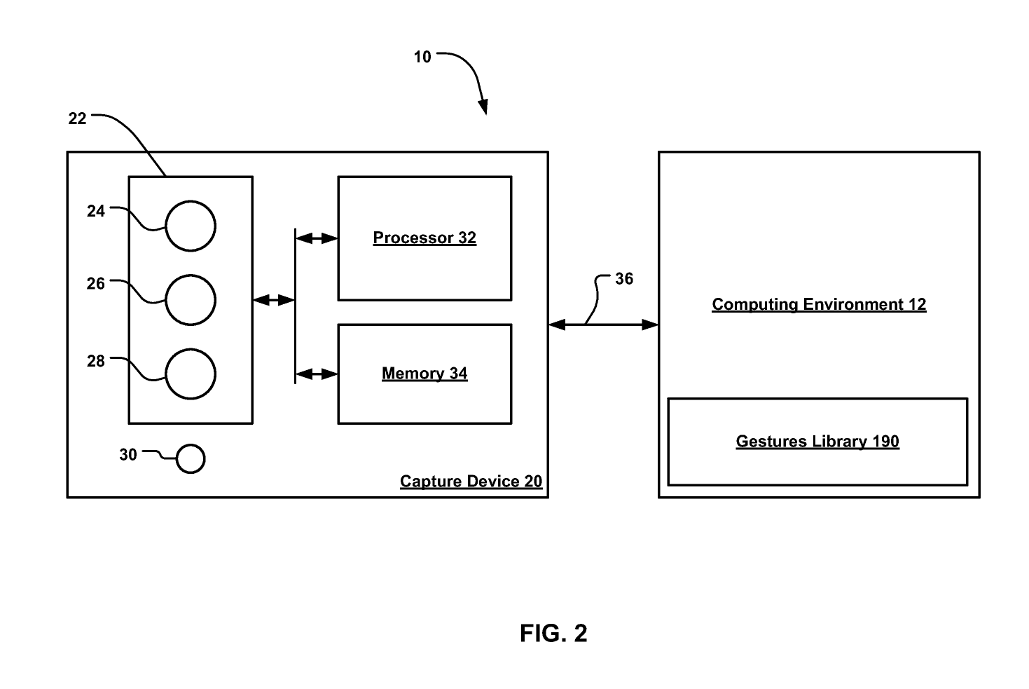

FIG. 2 illustrates an example embodiment of the capture device 20 that may be used in the target recognition, analysis, and tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device to a particular location on the targets or objects.

According to another embodiment, the capture device 20 may include two or more physically separated cameras that may view a scene from different angles to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions including, for example, instructions for receiving an image, generating a model of a user captured in the image, tracking the model, generating a motion capture file based on the tracked model, applying the motion capture file, or any other suitable instruction, which will be described in more detail below.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and/or a skeletal model that may be generated by the capture device 20 to the computing environment 12 via the communication link 36. The computing environment 12 may then use the model, depth information, and captured images to, for example, control an application such as a game or word processor and/or animate an avatar or on-screen character. For example, as shown, in FIG. 2, the computing environment 12 may include a gestures library 190. The gestures library 190 may include a collection of gesture filters, each comprising information concerning a gesture that may be performed by the skeletal model (as the user moves). The data captured by the cameras 26, 28 and the capture device 20 in the form of the skeletal model and movements associated with it may be compared to the gesture filters in the gesture library 190 to identify when a user (as represented by the skeletal model) has performed one or more gestures. Those gestures may be associated with various controls of an application. Thus, the computing environment 12 may use the gestures library 190 to interpret movements of the skeletal model and to control an application based on the movements.

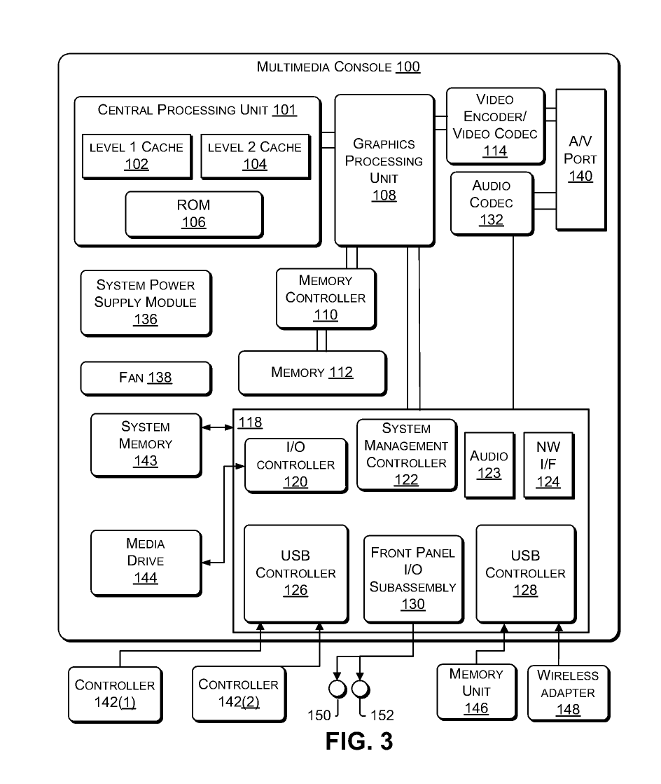

FIG. 3 illustrates an example embodiment of a computing environment that may be used to interpret one or more gestures in a target recognition, analysis, and tracking system and/or animate an avatar or on-screen character displayed by the target recognition, analysis, and tracking system. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100.

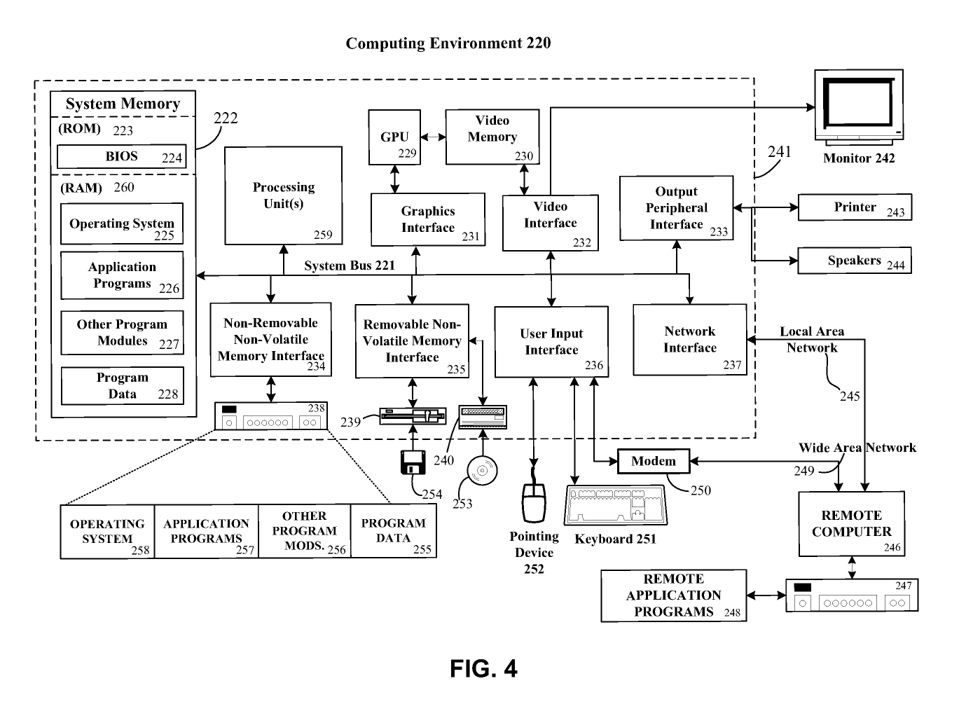

FIG. 4 illustrates another example embodiment of a computing environment 220 that may be the computing environment 12 shown in FIGS. 1A-2 used to interpret one or more gestures in a target recognition, analysis, and tracking system and/or animate an avatar or on-screen character displayed by a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

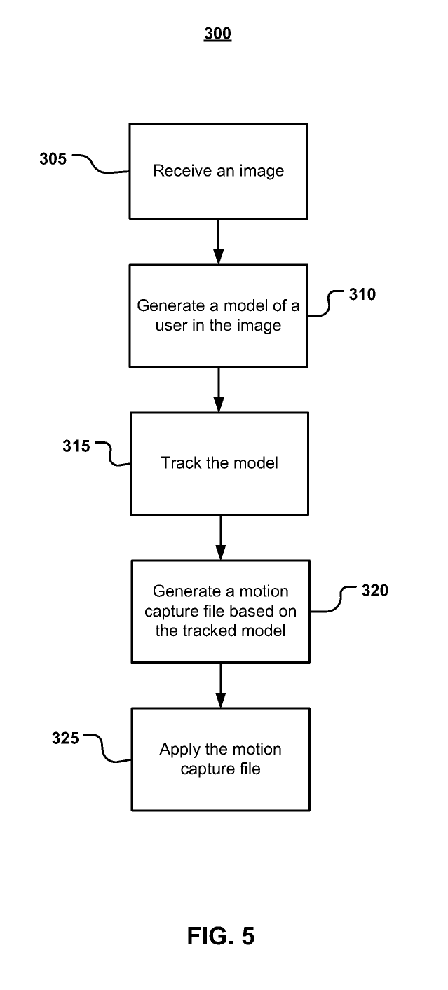

FIG. 5 depicts a flow diagram of an example method 300 for capturing motions a user in a scene. The example method 300 may be implemented using, for example, the capture device 20 and/or the computing environment 12 of the target recognition, analysis, and tracking system 10 described with respect to FIGS. 1A-4. In an example embodiment, the example method 300 may take the form of program code (i.e., instructions) that may be executed by, for example, the capture device 20 and/or the computing environment 12 of the target recognition, analysis, and tracking system 10 described with respect to FIGS. 1A-4.

According to one embodiment, at 305, an image may be received. For example, the target recognition, analysis, and tracking system may include a capture device such as the capture device 20 described above with respect to FIGS. 1A-2. The capture device may capture or observe a scene that may include one or more targets. In an example embodiment, the capture device may be a depth camera configured to obtain an image such as an RGB image, a depth image, or the like of the scene using any suitable technique such as time-of-flight analysis, structured light analysis, stereo vision analysis, or the like.

For example, in one embodiment, the image may include a depth image. The depth image may be a plurality of observed pixels where each observed pixel has an observed depth value. For example, the depth image may include a two-dimensional (2-D) pixel area of the captured scene where each pixel in the 2-D pixel area may represent a depth value such as a length or distance in, for example, centimeters, millimeters, or the like of an object in the captured scene from the capture device.

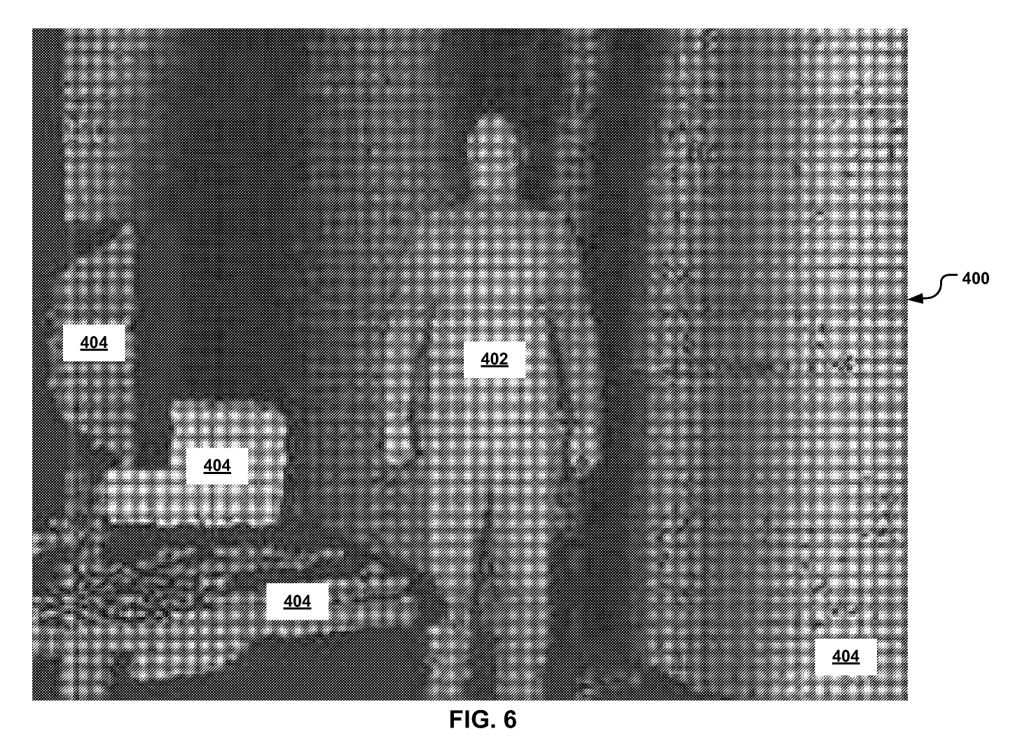

FIG. 6 illustrates an example embodiment of a depth image 400 that may be received at 305. According to an example embodiment, the depth image 400 may be an image or frame of a scene captured by, for example, the 3-D camera 26 and/or the RGB camera 28 of the capture device 20 described above with respect to FIG. 2. As shown in FIG. 6, the depth image 400 may include a human target 402 corresponding to, for example, a user such as the user 18 described above with respect to FIGS. 1A and 1B and one or more non-human targets 404 such as a wall, a table, a monitor, or the like in the captured scene. As described above, the depth image 400 may include a plurality of observed pixels where each observed pixel has an observed depth value associated therewith. For example, the depth image 400 may include a two-dimensional (2-D) pixel area of the captured scene where each pixel in the 2-D pixel area may represent a depth value such as a length or distance in, for example, centimeters, millimeters, or the like of a target or object in the captured scene from the capture device. In one embodiment, the depth image 400 may be colorized such that different colors of the pixels of the depth image correspond to and/or visually depict different distances of the human target 402 and non-human targets 404 from the capture device. For example, according to one embodiment, the pixels associated with a target closest to the capture device may be colored with shades of red and/or orange in the depth image whereas the pixels associated with a target further away may be colored with shades of green and/or blue in the depth image.

Referring back to FIG. 5, in one embodiment, upon receiving the image, at 305, the image may be downsampled to a lower processing resolution such that the depth image may be more easily used and/or more quickly processed with less computing overhead. Additionally, one or more high-variance and/or noisy depth values may be removed and/or smoothed from the depth image; portions of missing and/or removed depth information may be filled in and/or reconstructed; and/or any other suitable processing may be performed on the received depth information may such that the depth information may used to generate a model such as a skeletal model, which will be described in more detail below.

At 310, a model of a user in the image may be generated. For example, upon receiving the image, the target recognition, analysis, and tracking system may determine whether the depth image includes a human target corresponding to, for example, a user such as the user 18, described above with respect to FIGS. 1A-1B, by flood filling each target or object in the depth image and comparing each flood filled target or object to a pattern associated with a body model of a human in various positions or poses. The flood filled target or object that matches the pattern may then be isolated and scanned to determine values including, for example, measurements of various body parts. According to an example embodiment, a model such as a skeletal model, a mesh model, or the like may then be generated based on the scan. For example, according to one embodiment, measurement values that may be determined by the scan may be stored in one or more data structures that may be used to define one or more joints in a model. The one or more joints may be used to define one or more bones that may correspond to a body part of a human.

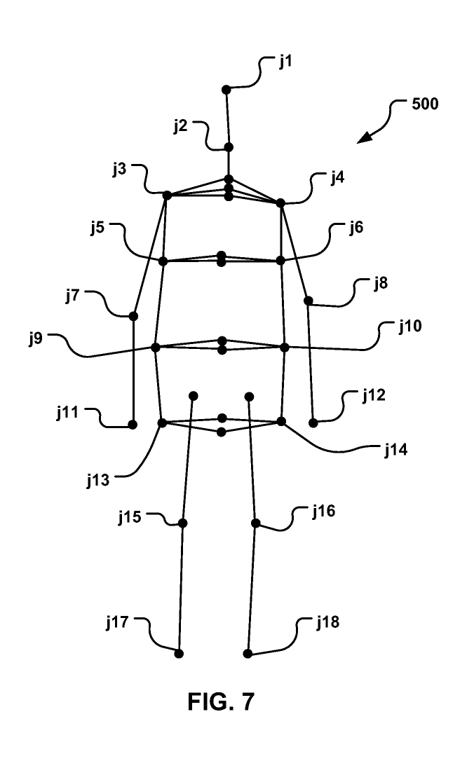

FIG. 7 illustrates an example embodiment of a model 500 that may be generated for a human target at, for example, 310. According to an example embodiment, the model 500 may include one or more data structures that may represent, for example, the human target 402 described above with respect to FIG. 6 as a three-dimensional model. Each body part may be characterized as a mathematical vector defining joints and bones of the model 500.

As shown in FIG. 7, the model 500 may include one or more joints j1-j18. According to an example embodiment, each of the joints j1-j18 may enable one or more body parts defined therebetween to move relative to one or more other body parts. For example, a model representing a human target may include a plurality of rigid and/or deformable body parts that may be defined by one or more structural members such as “bones” with the joints j1-j18 located at the intersection of adjacent bones. The joints j1-18 may enable various body parts associated with the bones and joints j1-j18 to move independently of each other. For example, the bone defined between the joints j7 and j11, shown in FIG. 7, may correspond to a forearm that may be moved independent of, for example, the bone defined between joints j15 and j17 that may correspond to a calf.

As described above, each of the body parts may be characterized as a mathematical vector having an X value, a Y value, and a Z value defining the joints and bones shown in FIG. 7. In an example embodiment, intersection of the vectors associated with the bones, shown in FIG. 7, may define the respective point associated with joints j1-j18.

Referring back to FIG. 5, at 315, the model may then be tracked such that the model may be adjusted based on movement by the user. According to one embodiment, the model such as the model 500 described above with respect to FIG. 7 may be a representation of a user such as the user 18 described above with respect to FIGS. 1A and 1B. The target recognition, analysis, and tracking system may observe or capture movements from the user such as the user 18 that may be used to adjust the model.

For example, a capture device such as the capture device 20 described above with respect to FIGS. 1A-2 may be observe or capture multiple images such as depth images, RGB images, or the like of a scene that may be used to adjust the model. According to one embodiment, each of the images may be observed or captured based on a defined frequency. For example, the capture device may observe or capture a new image of a scene every millisecond, microsecond, or the like.

Upon receiving each of the images, information associated with a particular image may be compared to information associated with the model to determine whether a movement may have been performed by the user. For example, in one embodiment, the model may be rasterized into a synthesized image such as a synthesized depth image. Pixels in the synthesized image may be compared to pixels associated with the human target in each of the received images to determine whether the human target in a received image has moved.

According to an example embodiment, one or more force vectors may be computed based on the pixels compared between the synthesized image and a received image. The one or more force may then be applied or mapped to one or more force-receiving aspects such as joints of the model to adjust the model into a pose that more closely corresponds to the pose of the human target or user in physical space.

According to another embodiment, the model may be adjusted to fit within a mask or representation of the human target in each of the received images to adjust the model based on movement of the user. For example, upon receiving each of the observed images, the vectors including the X, Y, and Z values that may define each of the bones and joints may be adjusted based on the mask of the human target in each of the received images. For example, the model may be moved in an X direction and/or a Y direction based on X and Y values associated with pixels of the mask of the human in each of the received images Additionally, joints and bones of the model may be rotated in a Z direction based on the depth values associated with pixels of the mask of the human target in each of the received images.

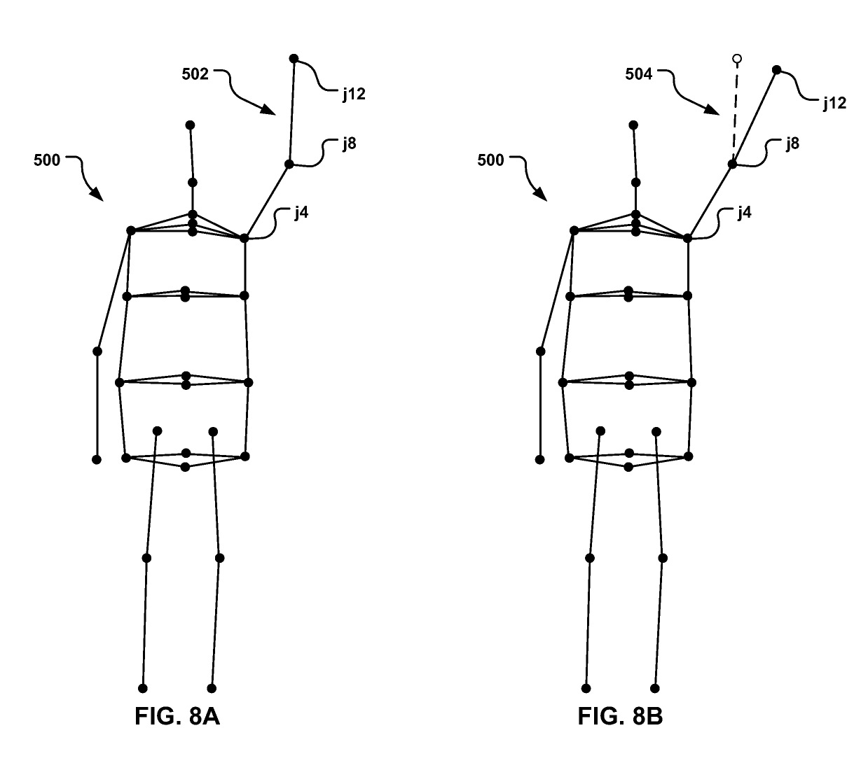

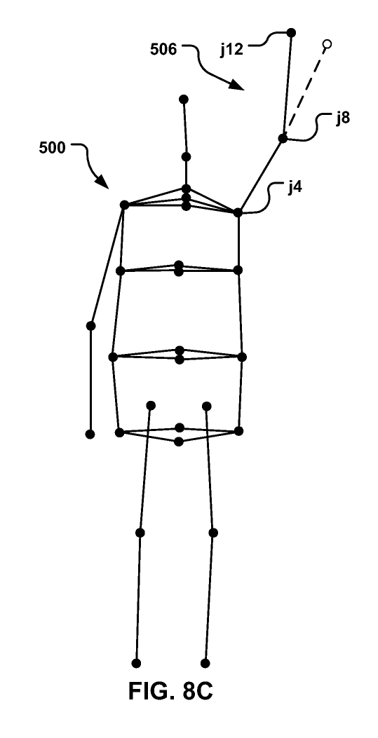

FIGS. 8A-8C illustrate an example embodiment of a model being adjusted based on movements or gestures by a user such as the user 18 described above with respect to FIGS. 1A and 1B. As shown in FIGS. 8A-8C, the model 500 described above with respect to FIG. 7 may be adjusted based on movements or gestures of the user at various points observed and captured in the depth images received at various points in time as described above. For example, as shown in FIG. 8A, the joints j4, j8, and j12 and the bones defined therebetween of the model 500 may be adjusted to represent pose 502 when the user raises his or her left arm by applying one or more force vectors or adjusting the model to fit with a mask for a human target in images received at various points in time as described above. The joints j8 and j12 and the bone defined therebetween may further be adjusted to a pose 504 and 506, as shown in FIGS. 8B-8C, when the user waves by moving his or her left forearm. Thus, according to an example embodiment, the mathematical vector defining the joints j4, j8, and j12 and the bones associated with the forearm and bicep therebetween may include vectors with an X value, a Y value, and a Z value that may be adjusted to correspond to poses 502, 504, and 506 by applying force vectors or fitting the model within a mask as described above.

Referring back to FIG. 5, at 320, a motion capture file of the tracked model may be generated. For example, the target recognition, analysis, and tracking system may render and store a motion capture file that may include one or more motions such as a waving motion, a swinging motion such as a golf swing, a punching motion, a walking motion, a running motion, or the like specific to the user such as the user 18 described above with respect to FIGS. 1A and 1B. According to one embodiment, the motion capture file may be generated in real-time based on the information associated with the tracked model. For example, in one embodiment, the motion capture file may include, for example, the vectors including the X, Y, and Z values that may define the joints and bones of the model as it is being tracked at various points in time.

In one example embodiment, a user may be prompted to perform various motions that may be captured in the motion capture file. For example, an interface may be displayed that may prompt the user to, for example, walk or perform a golf swing motion. As described above, the model being tracked may then be adjusted based on those motions at various points in time and a motion capture file of the model for the prompted motion may be generated and stored.

In another embodiment, the motion capture file may capture the tracked model during natural movement by the user interacting with the target recognition, analysis, and tracking system. For example, the motion capture file may be generated such that the motion capture file may naturally capture any movement or motion by the user during interaction with the target recognition, analysis, and tracking system.

According to one embodiment, the motion capture file may include frames corresponding to, for example, a snapshot of the motion of the user at different points in time. Upon capturing the tracked model, information associated with the model including any movements or adjustment applied thereto at a particular point in time may be rendered in a frame of the motion capture file. The information in the frame may include, for example, the vectors including the X, Y, and Z values that may define the joints and bones of the tracked model and a time stamp that may be indicative of a point in time in which, for example, the user performed the movement corresponding to the pose of the tracked model.

For example, as described above with respect to FIGS. 8A-8C, the model 500 may be tracked and adjusted to form poses 502, 504, and 506 that may be indicative of the user waving his or her left hand at particular points in time. The information associated with joints and bones of the model 500 for each of the poses 502, 504, and 506 may be captured in a motion capture file.

For example, pose 502 of the model 500, shown in FIG. 8A, may correspond to a point in time when a user initially raises his or her left arm. The pose 502 including information such as the X, Y, and Z values of the joints and bones for the pose 502 may be rendered in, for example, a first frame of the motion capture file having a first time stamp associated with the point in time after the user raises his or her left arm.

Similarly, poses 504 and 506 of the model 500, shown in FIGS. 8B and 8C, may correspond to a point in time when a user waves his or her left hand. The poses 504 and 506 including information such as the X, Y, and Z values of the joints and bones for the poses 504 and 506 may be rendered in, for example, respective second and third frames of the motion capture file having respective second and third time stamps associated with different point in time of the user waving his or her left hand.

According to an example embodiment, the first, second, and third frames associated with the poses 502, 504, and 506 may be rendered in the motion capture file in a sequential time order at the respective first, second, and third time stamps. For example, the first frame rendered for the pose 502 may have a first time stamp of 0 seconds when the user raises his or her left arm, the second frame rendered for the pose 504 may have a second time stamp of 1 second after the user moves his or her left hand in an outward direction to begin a waving motion, and the third frame rendered for the pose 506 may have a third time stamp of 2 seconds when the user moves his or her left hand in an inward direction to complete a waving motion.

At 325, the motion capture file may be applied to an avatar or game character. For example, the target recognition, analysis, and tracking system may apply one or more motions of the tracked model captured in the motion capture file to an avatar or game character such that the avatar or game character may be animated to mimic motions performed by the user such as the user 18 described above with respect to FIGS. 1A and 1B. In an example embodiment, the joints and bones in the model captured in the motion capture file may be mapped to particular portions of the game character or avatar. For example, the joint associated with the right elbow may be mapped to the right elbow of the avatar or game character. The right elbow may then be animated to mimic the motions of the right elbow associated with the model of the user in each frame of the motion capture file.

According to an example embodiment, the target recognition, analysis, and tracking system may apply the one or more motions as the motions are captured in the motion capture file. Thus, when a frame is rendered in the motion capture file, the motions captured in the frame may be applied to the avatar or game character such that the avatar or game character may be animated to immediately mimic the motions captured in the frame.

In another embodiment, the target recognition, analysis, and tracking system may apply the one or more motions after the motions may be captured in a motion capture file. For example, a motion such as a walking motion may be performed by the user and captured and stored in the motion capture file. The motion such as the walking motion may then be applied to the avatar or game character each time, for example, the user subsequently performs a gesture recognized as a control associated with the motion such as the walking motion of the user. For example, when a user lifts his or her left leg, a command that causes the avatar to walk may be initiated. The avatar may then begin walking and may be animated based on the walking motion associated with the user and stored in the motion capture file.

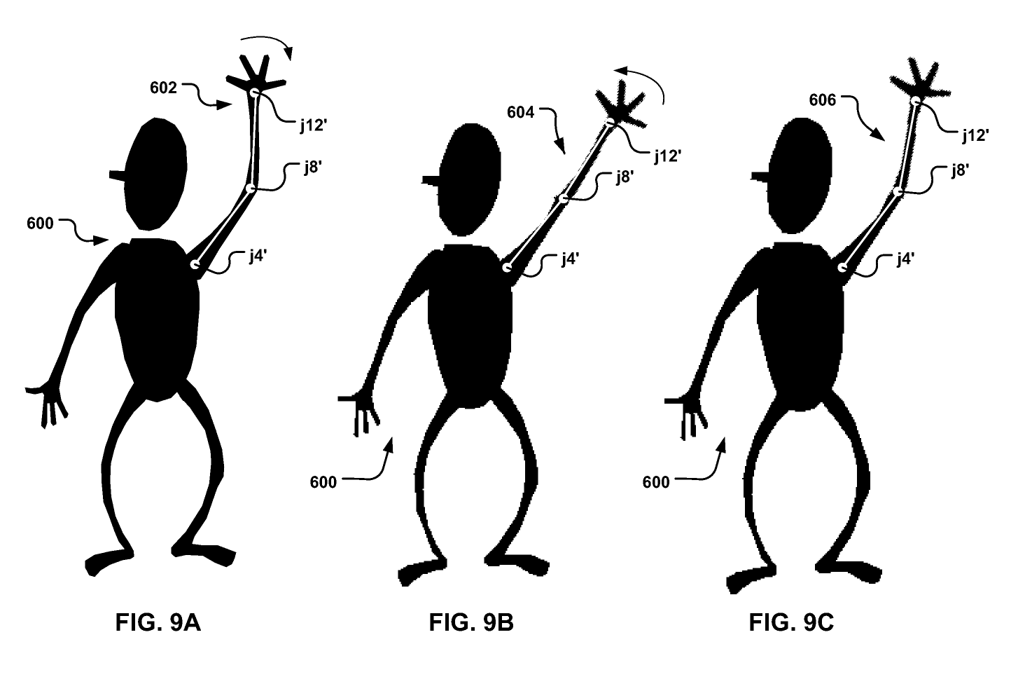

FIGS. 9A-9C illustrate an example embodiment of an avatar or game character 600 that may be animated based on a motion capture file at, for example, 325. As shown in FIGS. 9A-9C, the avatar or game character 600 may be animated to mimic a waving motion captured for the tracked model 500 described above with respect to FIGS. 8A-8C. For example, the joint j4, j8, and j12 and the bones defined therebetween of the model 500 shown in FIGS. 8A-8C may be mapped to a left shoulder joint j4′, a left elbow joint j8′, and a left wrist joint j12′ and the corresponding bones of the avatar or game character 600 as shown in FIGS. 9A-9C. The avatar or game character 600 may then be may animated into poses 602, 604, and 606 that mimic the poses 502, 504, and 506 of the model 500 shown in FIGS. 8A-8C at the respective first, second, and third time stamps in the motion capture file.

Thus, in an example embodiment, the visual appearance of an on-screen character may be changed in response to the motion capture file. For example, a game player such as the user 18 described above with respect to FIGS. 1A-1B playing an electronic game on a gaming console may be tracked by the gaming console as described herein. As the game player swings an arm, the gaming console may track this motion, then in response to the tracked motion, adjust the model such as the skeletal model, mesh model, or the like associated with the user accordingly. As described above, the tracked model may further be captured in a motion capture file. The motion capture file may then be applied to the on-screen character such that the on-screen character may be animated to mimic the actual motion of the user swinging their arm. According to example embodiments, the on-screen character may be animated to swing, for example, a golf club, a bat, or throw a punch in a game exactly like the user swings his or her arm.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

What is claimed:

1. A device for capturing motions a user in a scene, the device comprising:
a camera component, wherein the camera component receives an image of the scene; and
a processor, wherein the processor executes computer executable instructions, and wherein the computer executable instructions comprise instructions for:
receiving the image of the scene from the camera component;
generating a model associated with the user in the image;
tracking the model in response to movement by the user; and
generating a motion capture file for the movement of user in real-time based on the tracked model.

2. The device of claim 1, wherein the image comprises a depth image.

3. The device of claim 1, wherein the movement by the user comprises one or more motions of one or more body parts associated with the user in physical space.

4. The device of claim 1, wherein the instructions for generating the motion capture file for the movement of the user in real-time based on the tracked model comprise instructions for:
capturing a first pose of the tracked model in response to the movement by the user; and
rendering a first frame at a first time stamp in the motion capture file that includes the first pose of the tracked model.

5. The device of claim 4, wherein the instructions for generating the motion capture file for the movement of the user in real-time based on the tracked model comprise instructions for:
capturing a second pose of the tracked model in response to the movement by the user; and
rendering a second frame at a second time stamp in the motion capture file that includes the second pose of the tracked model.

6. The device of claim 5, wherein the first frame and the second frame are rendered in the motion capture file in a sequential time order corresponding to the first time stamp and the second time stamp.

7. The device of claim 6, wherein the model comprises a skeletal model having joints and bones.

8. The device of claim 7, wherein the first frame comprises a first set of vectors that define the joints and the bones in the first pose, and wherein the second frame comprises a second set of vectors that define the joints and the bones in the second pose.

9. The device of claim 1, further comprising instructions for providing the motion capture file to a computing system, wherein the computing system animates an avatar using the motion capture file.

10. A computer-readable storage medium having stored thereon computer executable instructions for capturing motions a user in a scene, the computer executable instructions comprising instructions for:
receiving an image of the scene;
generating a model of the user in the image;
adjusting the model to mimic a movement by the user; and
generating a motion capture file of the movement of the user based the adjusted model.

11. The computer-readable storage medium of claim 10, wherein the image comprises a depth image.

12. The computer-readable storage medium of claim 10, wherein the movement by the user comprises one or more motions of one or more body parts associated with the user in physical space.

13. The computer-readable storage medium of claim 10, wherein the model comprises a skeletal model having joints and bones.

14. The computer-readable storage medium of claim 13, wherein the instructions for generating the motion capture file of the movement of the user based the adjusted model further comprise instructions for:
capturing a pose the adjusted model; and
rendering a frame in the motion capture file that includes the pose of the adjusted model.

15. The computer-readable storage medium of claim 14, wherein the frame comprises a set of vectors that define the joints and the bones in the pose.

16. The computer-readable storage medium of claim 13, further comprising instructions for applying the motion capture file to an avatar.

17. The computer-readable medium of claim 16, wherein the instructions for applying the motion capture file to the avatar further comprise instructions for:
mapping the joints and the bones of the model to particular portions of the avatar; and
animating the particular portions of the avatar to mimic motions of the joints and the bones in the adjusted model.

18. A system for rendering a model of a user; the system comprising:
a capture device, wherein the capture device comprises a camera component that receives a depth image of a scene; and
a computing device in operative communication with the capture device, wherein the computing device comprises a processor that generates a model of the user in the image, tracks the model in response to movements by the user, applies the movements of the user to the tracked model, and generates a motion capture file of the movements of the user in real-time based the tracked model.

19. The system of claim 18, wherein the model comprises a skeletal model having joints and bones.

20. The system of claim 18, wherein the processor applies the motion capture file to an avatar.

21. The system of claim 20, wherein the processor applies the motion capture file to the avatar by mapping the joints and the bones of the model to particular portions of the avatar, and animating the particular portions of the avatar to mimic the movements of the user applied to the joints and the bones of the tracked model.

22. The system of claim 20, wherein the computing device further comprises a gestures library stored thereon, and wherein the processor compares one or more of the movements applied to the tracked model with the gestures library to determine whether to apply the motion capture file to the avatar.
